(19) United States
(12) Patent Application Publication
(10) Pub. No.: US 2019/0056677 A1
(43) Pub. Date: Feb. 21, 2019

(54) IMAGE FORMING APPARATUS

(71) Applicant: FUJI XEROX CO.,LTD., Tokyo (JP)

(72) Inventors: Tomoya OKI, Kanagawa (JP); Hirofumi IIDA, Kanagawa (JP)

(73) Assignee: FUJI XEROX CO.,LTD., Tokyo (JP)

(21) Appl. No.: 15/947,870

(22) Filed: Apr. 9, 2018

(30) Foreign Application Priority Data
Aug. 17, 2017 (JP) 2017-157405

(51) Int. Cl. G03G 9/08; G03G 15/16

(52) U.S. Cl. CPC G03G 9/0827; G03G 2215/1666; G03G 15/1695

(57) ABSTRACT

An image forming apparatus includes an image carrier that holds an electrostatic latent image and a toner image while rotating, a charger that charges the image carrier, an exposure unit that radiates light onto the image carrier to form an electrostatic latent image, a developing unit that develops the electrostatic latent image with toner, a transfer unit that transfers a toner image onto a sheet, a fixing unit that fixes the toner image onto the sheet, a charging-bias power supply that applies charging bias to the charger, a transfer-bias power supply that applies reverse transfer bias to the transfer unit, and a controller that causes the charging-bias power supply to apply the charging bias to the charger, the transfer-bias power supply to apply the reverse transfer bias to the transfer unit, and the exposure unit to radiate the light onto a region of the image carrier.

### CROSS-REFERENCE TO RELATED APPLICATIONS

This application is based on and claims priority under 35 USC 119 from Japanese Patent Application No. 2017-157405 filed Aug. 17, 2017.

### BACKGROUND

### (i) Technical Field

The present invention relates to an image forming apparatus.

### (ii) Related Art

In the case where an erasing unit, such as an erase lamp, that erases static charge from an image carrier before a portion of the image carrier, the portion facing a transfer unit, is charged again is not provided, the next charging is performed while the charge potential of the image carrier has increased as a result of a reverse transfer bias being applied to the transfer unit.

### SUMMARY

According to an aspect of the invention, there is provided an image forming apparatus including an image carrier that holds, while rotating, an electrostatic latent image formed through charging and light exposure steps, which are included in a toner-image forming process, and a toner image formed through a development step, which is included in the toner-image forming process, the development step using a toner contained in a developer, which contains the toner and a carrier, a charger that is disposed at a charging position facing the image carrier and that charges the image carrier as a result of a charging bias being applied to the charger, an exposure unit that radiates exposure light carrying image information onto the image carrier in such a manner as to form an electrostatic latent image onto the image carrier, a developing unit that is disposed at a developing position facing the image carrier and that develops the electrostatic latent image on the image carrier with the toner contained in the developer as a result of a developing bias being applied to the developing unit, a transfer unit that is disposed at a transfer position facing the image carrier and that nips a sheet, which is transported, between the transfer unit and the image carrier and transfers a toner image on the image carrier onto the sheet as a result of a transfer bias being applied to the transfer unit, a fixing unit that fixes a toner image on a sheet that has been further transported after the toner image has been transferred to the sheet onto the sheet, a charging-bias power supply that applies the charging bias to the charger in such a manner that voltage is capable of being freely adjusted, a transfer-bias power supply that applies a reverse transfer bias having a polarity opposite to a polarity of the transfer bias to the transfer unit in a switchable manner, and a controller that causes the charging-bias power supply to apply the charging bias, which monotonically changes with time, to the charger over a predetermined transition period during a period when the toner-image forming process is not performed, causes the transfer-bias power supply to apply the reverse transfer bias to the transfer unit over a predetermined reverse transfer period within a transit period in which a transient charged region of the image carrier that has passed through the charging position within the transition period passes through the transfer position, and causes the exposure unit to radiate the exposure light onto a reverse transfer region of the image carrier before the reverse transfer region that has passed through the transfer position within the reverse transfer period reaches the developing position.

### BRIEF DESCRIPTION OF THE DRAWINGS

An exemplary embodiment of the present invention will be described in detail based on the following figures, wherein:

FIG. 1 is a schematic diagram of a printer that is an image forming apparatus according to an exemplary embodiment of the present invention;

FIG. 2 is an enlarged view illustrating a structure around the periphery of an image carrier included in the printer illustrated in FIG. 1;

FIGS. 3A to 3D are diagrams illustrating an image-forming preparation sequence performed around the periphery of the image carrier by a controller and a power supply unit;

FIGS. 4A to 4C are diagrams illustrating an effect according to the exemplary embodiment; and

FIGS. 5A to 5C are diagrams illustrating a comparative example of the effect according to the exemplary embodiment, which is illustrated in FIGS. 4A to 4C.

### DETAILED DESCRIPTION

An exemplary embodiment of the present invention will be described below.

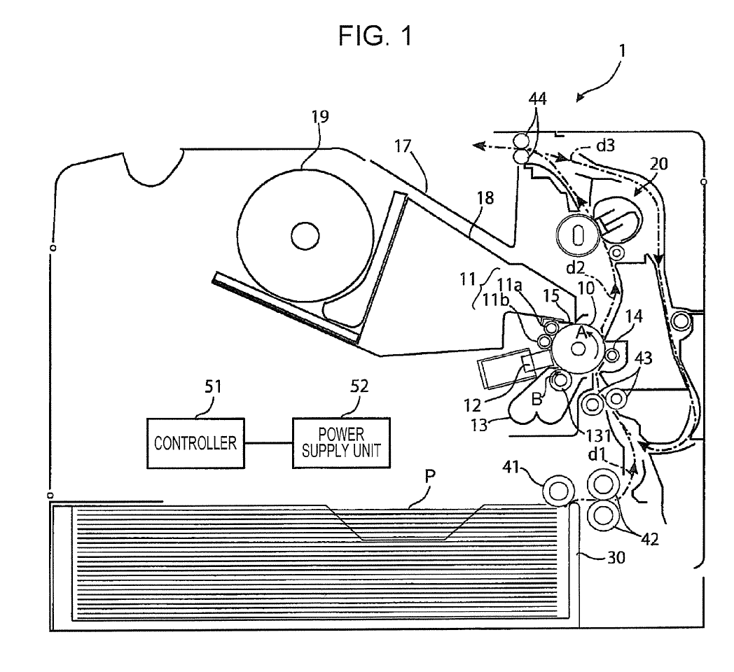

FIG. 1 is a schematic diagram of a printer that is an image forming apparatus according to the exemplary embodiment of the present invention.

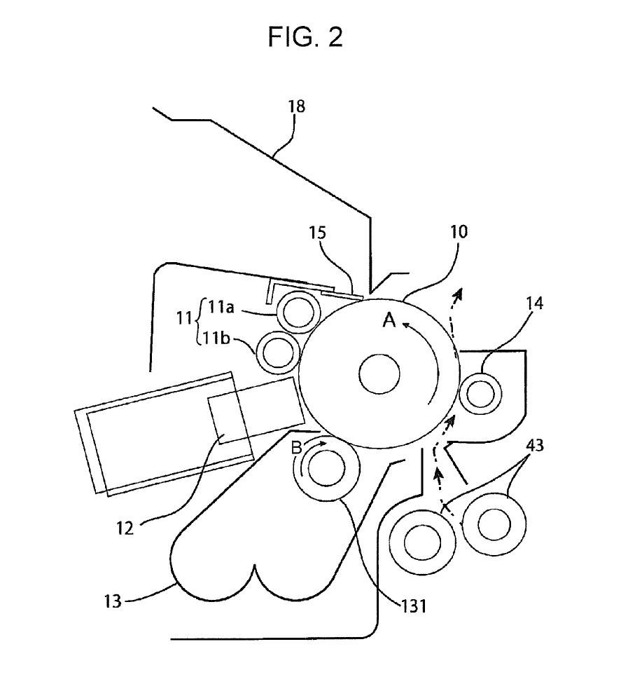

FIG. 2 is an enlarged view illustrating a structure around the periphery of an image carrier included in the printer illustrated in FIG. 1.

A printer 1 illustrated in FIG. 1 is a printer that receives image data from, for example, an external personal computer (hereinafter abbreviated to PC), employs an electrophotographic system, and outputs an image based on the image data onto one of sheets P. A left side surface illustrated in FIG. 1 is the front surface of the printer 1.

The printer 1 includes an image carrier 10. The image carrier 10 holds, while rotating in the direction of arrow A, an electrostatic latent image that is formed through charging and light exposure steps. In addition, the image carrier 10 holds a toner image that is formed through a development step using a toner contained in a developer, which contains the toner and a carrier.

A charging bias having a negative (−) potential is applied to a charger 11 according to the present exemplary embodiment, and the charger 11 charges a surface of the image carrier 10 to the negative (−) potential. The charger 11 charges the surface of the image carrier 10 with the aim of causing the surface of the image carrier 10 to have a predetermined target charging potential. The charger 11 according to the present exemplary embodiment includes two charging rollers 11a and 11b that are arranged in the direction of rotation of the image carrier 10. These two charging rollers 11a and 11b are connected to a common power supply are applied with the same charging bias. In the present exemplary embodiment, the charger 11 includes the two charging rollers 11a and 11b in order to enhance the charging ability.

An exposure unit 12 radiates exposure light carrying image information onto the image carrier 10 in such a manner as to form an electrostatic latent image onto the surface of the image carrier 10. The exposure unit 12 according to the present exemplary embodiment includes a large number of LED light sources that are arranged in a scanning direction (in the direction perpendicular to FIG. 1 and FIG. 2).

A developing unit 13 contains the developer (not illustrated), which contains the carrier and the toner. The developer in the developing unit 13 is transported by a developing roller 131 to a developing position facing the image carrier 10. A developing bias is applied to the developing roller 131, and, by operation of the developing bias, an electrostatic latent image on the image carrier 10 is developed with the toner contained in the developer, so that a toner image is formed onto the image carrier 10.

The printer 1 includes a removable toner cartridge 19 that contains a replenishing toner. When the amount of the toner in the developing unit 13 decreases, the developing unit 13 is replenished with the replenishing toner from the toner cartridge 19 by an amount corresponding to the decreased amount.

A transfer bias is applied to a transfer unit 14. As a result of the transfer bias been applied to the transfer unit 14, the transfer unit 14 transfers a toner image formed on the image carrier 10 onto one of the sheets P in a manner described later. Here, the transfer unit 14 according to the present exemplary embodiment is a transfer roller that has a roll-like shape or a substantially roll-like shape and that transfers a toner image formed on the image carrier 10 onto one of the sheets P while rotating along with rotation of the image carrier 10.

The toner image that has been transferred to the sheet P is fixed onto the sheet P by being heated and pressurized by a fixing unit 20.

A cleaning unit 15 scrapes off the toner that remains on the image carrier 10 after a toner image has been transferred and places the toner into a waste-toner tank 18.

Note that the printer 1 does not include an erasing unit, such as an erase lamp, that erases static charge from the image carrier 10 on a path along which a portion of the image carrier 10, the portion facing the transfer unit 14 as a result of rotation of the image carrier 10, moves to a position at which the portion of the image carrier 10 faces the charger 11 as a result of rotation of the image carrier 10.

A sheet cartridge 30 is disposed in a lower portion of the printer 1 in such a manner as to be capable of being drawn out toward the left side in FIG. 1. The plural sheets P on each of which an image is to be printed are stacked on top of one another in the sheet cartridge 30. When a printing operation is performed, one of the sheets P accommodated in the sheet cartridge 30, the sheet P being at the top of the sheets P, is picked up by a pickup roller 41. Even in the case where some of the sheets P are taken out while superposed with each other, a pair of separation rollers 42 separate the sheets P one by one with certainty, and only one of the sheets P is transported along a transport path d1 and reaches a pair of registration rollers 43. The registration rollers 43 serve to correct the position of the sheet P, which has been transported. In addition, the registration rollers 43 serve to adjust the timing of subsequent transportation of the sheet P and to send out the sheet P further toward the downstream side. The registration rollers 43 send out the sheet P in accordance with the timing of transportation of a toner image on the image carrier 10, and the toner image on the image carrier 10 is transferred onto the sheet P. The sheet P, to which the toner image has been transferred, is further transported along a transport path d2 in such a manner as to pass through the fixing unit 20, so that the toner image is fixed onto the sheet P. Then, the sheet P is ejected by a pair of sheet-ejection rollers 44 to a sheet-ejection tray 17 that is provided in an upper portion of the printer 1.

In the case of printing images on two surfaces of one of the sheets P, the sheet P that has an image printed on one surface thereof in a manner similar to the above is partially sent out by the sheet-ejection rollers 44. Then, the sheet-ejection rollers 44 rotate in a reverse direction, and the sheet P is transported along a transport path d3 this time and reaches the registration rollers 43 again. After that, the above-described printing operation is repeated, and the sheet P having images printed on the two surfaces thereof is ejected to the sheet-ejection tray 17 by the sheet-ejection rollers 44.

The printer 1 further includes a controller 51 and a power supply unit 52. The controller 51 performs overall control of a printing operation performed by the printer 1 and control of the power supply unit 52. The power supply unit 52 serves to, under control of the controller 51, supply power to the entire printer 1, the power including the charging bias that is applied to the charger 11, the developing bias that is applied to the developing roller 131, and the transfer bias that is applied to the transfer unit 14. The controller 51 corresponds to an example of a controller according to the exemplary embodiment of the present invention. The power supply unit 52 corresponds to an example of a charging-bias power supply according to the exemplary embodiment of the present invention and also corresponds to an example of a transfer-bias power supply according to the exemplary embodiment of the present invention.

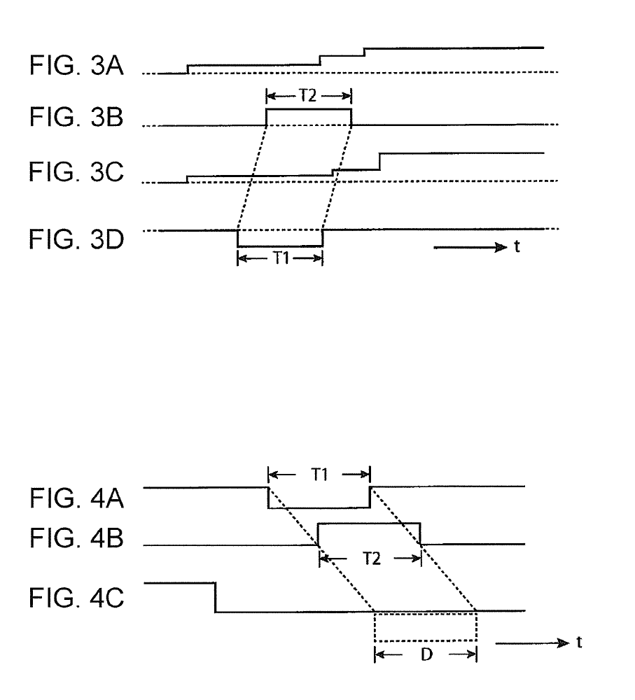

FIGS. 3A to 3D are diagrams illustrating an image-forming preparation sequence performed around the periphery of the image carrier by the controller and the power supply unit. In each of FIGS. 3A to 3D, the horizontal axis is a time axis t. Note that, in the following description, the levels of biases and potentials refer to the levels of the absolute values of the biases and the potentials unless otherwise stated.

In a state where the image carrier 10 is in a standby state in which the image carrier 10 is not rotating, when image data is input to the printer 1 from, for example, an external PC, the image carrier 10 starts rotating, and the image-forming preparation sequence illustrated in FIGS. 3A to 3D is performed. When the image-forming preparation sequence is complete, an operation of printing an image based on the input image data is performed. This printing operation includes an example of a toner-image forming process according to the exemplary embodiment of the present invention.

There is a case where the transfer unit 14 becomes contaminated as a result of, for example, the toner spilled from both sides of one of the sheets P to which a toner image has been transferred or the toner deposited on the image carrier 10 when any of the sheets P is not present between the image carrier 10 and the transfer unit 14 being deposited onto the transfer unit 14. Accordingly, in the present exemplary embodiment, in order to remove such contaminants from the transfer unit 14, the reverse transfer bias is applied to the transfer unit 14 in a reverse transfer period that is a partial period T1 included in a period of time during which the image-forming preparation sequence illustrated in FIGS. 3A to 3D is performed. The reverse transfer bias is a bias having a polarity opposite to the polarity of the transfer bias applied to the transfer unit 14 when a toner image on the image carrier 10 is transferred onto one of the sheets P. When the reverse transfer bias is applied to the transfer unit 14, the contaminants including the toner deposited on the transfer unit 14 are transferred onto the image carrier 10. Then, the contaminants including the toner that have been transferred to the image carrier 10 are scraped off from the image carrier 10 by the cleaning unit 15 and placed into the waste-toner tank 18.

Here, although the reverse transfer bias is applied to the transfer unit 14 within the period of time during which the image-forming preparation sequence illustrated in FIGS. 3A to 3D is performed, the reverse transfer bias may be applied to the transfer unit 14 within a period of time during which a standby transition sequence, in which the image carrier 10 that has been rotating stops rotating and transitions to the standby state, is performed after a printing operation has been completed.

Here, the period of time during which the image-forming preparation sequence is performed and the period of time during which the standby transition sequence is performed correspond to examples of a transition period according to the exemplary embodiment of the present invention. The reverse transfer bias is applied to the transfer unit 14 in the reverse transfer period, which is a partial period included in the period of time during which the image-forming preparation sequence is performed or a partial period included in the period of time during which the standby transition sequence is performed. The reverse transfer period corresponds to an example of a reverse transfer period according to the exemplary embodiment of the present invention.

The image-forming preparation sequence illustrated in FIGS. 3A to 3D will now be described as an example. The image-forming preparation sequence is a sequence of operations that is performed under control of the controller 51 (see FIG. 1).

FIG. 3A illustrates the charging bias that is applied to the charger 11. In the standby state in which the image-forming preparation sequence has not yet been started, the charging bias is not applied to the charger 11, and when the image-forming preparation sequence is started, the charging bias that is applied to the charger 11 is gradually increased as illustrated in FIG. 3A.

FIG. 3B illustrates a sequence of operations for exposing the image carrier 10 to the exposure light performed by the exposure unit 12.

Although the exposure unit 12 performs light exposure when an electrostatic latent image is formed onto the image carrier 10, the exposure unit 12 also performs the light exposure during the period of time during which the image-forming preparation sequence is performed. Details of the light exposure will be described later.

FIG. 3C illustrates a DC component of the developing bias that is applied to the developing unit 13.

In the standby state, the developing bias is not applied to the developing unit 13, and when the image-forming preparation sequence is started, similar to the charging bias applied to the charger 11, the developing bias that is applied to the developing unit 13 is gradually increased as illustrated in FIG. 3C.

FIG. 3D illustrates the transfer bias that is applied to the transfer unit 14.

During the period when the image-forming preparation sequence illustrated in FIGS. 3A to 3D is performed, the transfer bias having a polarity that causes a toner image on the image carrier 10 to be transferred onto one of the sheets P is not applied to the transfer unit 14. Instead of the transfer bias, the reverse transfer bias having a polarity opposite to the polarity of the transfer bias is applied to the transfer unit 14 in the partial period T1, which is included in the period of time during which the image-forming preparation sequence is performed. As described above, when the reverse transfer bias is applied to the transfer unit 14, the contaminants including the toner deposited on the transfer unit 14 are transferred onto the image carrier 10 and are eventually placed into the waste-toner tank 18. In addition, as described above, the transfer unit 14 according to the present exemplary embodiment is a transfer roller that has a roll-like shape or a substantially roll-like shape and that rotates along with rotation of the image carrier 10, and the partial period T1 in which the reverse transfer bias is applied to the transfer roller is set to a period of time taken for the transfer roller to make at least one rotation or about at least one rotation and less than two rotations or about two rotations. This is because it is preferable that the contaminants including the toner deposited on the entire peripheral surface of the transfer roller be transferred onto the image carrier 10, and also it is preferable that application of the reverse transfer bias be completed as short a time as possible in order to reduce stress applied to the image carrier 10 as much as possible.

As seen from positions around the periphery of the image carrier 10 illustrated in FIG. 1 and FIG. 2 and rotation of the image carrier 10 in the direction of arrow A, the positions including a charging position at which the charger 11 is disposed, a light-exposure position at which the exposure unit 12 radiates the exposure light onto the image carrier 10, a developing position at which the developing unit 13 is disposed, and a transfer position at which the transfer unit 14 is disposed, a reverse transfer region D of the image carrier 10 that has passed through the transfer position and received the contaminants including the toner from the transfer unit 14 in the partial period T1, in which the reverse transfer bias is applied to the transfer unit 14, reaches the light-exposure position with a time lag and then reaches the developing position with another time lag.

The exposure unit 12 radiates the exposure light onto the reverse transfer region D of the image carrier 10, which has passed through the transfer position in the above-mentioned partial period T1, before the reverse transfer region D reaches the developing position.

More specifically, the exposure unit 12 radiates the exposure light onto the image carrier 10 only during a partial period T2 illustrated in FIG. 3B. The partial period T2 is a period of time during which the exposure light is radiated onto the reverse transfer region D of the image carrier 10 that corresponds to the partial period T1 illustrated in FIG. 3D. In the present exemplary embodiment, the partial period T2 is set to barely include the partial period T1, in which the reverse transfer bias is applied to the transfer unit 14. This is because the image carrier 10 deteriorates as a result of being irradiated with the exposure light, and thus, it is preferable to set the length of time over which the exposure light is radiated as short as possible.

The exposure unit 12 radiates, onto the reverse transfer region D of the image carrier 10, exposure light having an intensity less than that of the exposure light that is radiated onto the image carrier 10 when an electrostatic latent image is formed onto the image carrier 10. This is because exposure light having an intensity that provides an effect, which will be described later, is sufficient as the exposure light that is radiated in the partial period T2, and if exposure light having unnecessarily high intensity is radiated onto the image carrier 10, there is a possibility that deterioration of the image carrier 10 may be accelerated by the high-intensity exposure light.

The controller 51 monitors a usage history of the image carrier 10 including, for example, a history indicating the number of sheets that have been printed out by using the image carrier 10. In addition, the controller 51 causes the exposure unit 12 to radiate the exposure light onto the reverse transfer region D of the image carrier 10 in accordance with the usage history such that the intensity of the exposure light decreases as the number of times the image carrier 10 is used increases. This is because, as the number of times the image carrier 10 is used increases, the surface of the image carrier 10 becomes worn and becomes sensitive to the exposure light. Accordingly, exposure light having low intensity is sufficient, and if exposure light having high intensity is radiated onto the image carrier 10, deterioration of the image carrier 10 will be accelerated.

FIGS. 4A to 4C are diagrams illustrating an effect according to the exemplary embodiment.

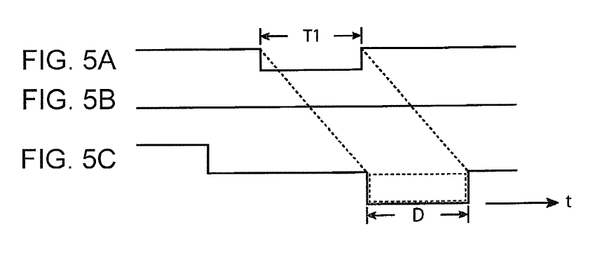

FIGS. 5A to 5C are diagrams illustrating a comparative example of the effect according to the exemplary embodiment, which is illustrated in FIGS. 4A to 4C.

Each of FIG. 4A and FIG. 5A illustrates the period T1 in which the reverse transfer bias is applied to the transfer unit 14. Each of FIG. 4B and FIG. 5B illustrates the period T2 in which the exposure unit 12 radiates the exposure light onto the image carrier 10. However, FIG. 5B illustrates the case where the exposure light is not radiated. Each of FIG. 4C and FIG. 5C illustrates the surface potential of the image carrier 10. Here, the absolute value of the potential becomes larger toward the lower side in each of FIG. 4C and FIG. 5C. Note that, in each of FIGS. 4A to 4C and 5A to 5C, the horizontal axis is the time axis t.

The comparative example illustrated in FIGS. 5A to 5C will be described first.

In the comparative example illustrated in FIGS. 5A to 5C, a reverse transfer region D of the image carrier 10 that corresponds to the period T1, in which the reverse transfer bias is applied to the transfer unit 14, is influenced by the reverse transfer bias applied to the transfer unit 14, and the surface potential (absolute value) of the reverse transfer region D of the image carrier 10 increases. This increase in the surface potential implies that an electrostatic force in a direction in which the carrier, which is contained in the developer in the developing unit 13, tries to move toward the image carrier 10 increases, and consequently, the carrier is more likely to move. When the amount of the carrier in the developer in the developing unit 13 becomes insufficient as a result of the carrier moving toward the image carrier 10, there is a possibility that normal development of an electrostatic latent image will not be performed, which in turn leads to an image quality defect.

Accordingly, in the present exemplary embodiment, as illustrated in FIGS. 4A to 4C, the exposure light is radiated onto the reverse transfer region D of the image carrier 10. As a result, an increase in the surface potential of the reverse transfer region D is suppressed. Therefore, even when the reverse transfer region D moves to the developing position and faces the developing unit 13, transfer of the carrier contained in the developer in the developing unit 13 toward the image carrier 10 is suppressed.

Note that, although the image-forming preparation sequence in which the image carrier 10 in the standby state starts rotating has been described as an example, in the present exemplary embodiment, in a manner similar to the above, the exposure light is also radiated onto the reverse transfer region D of the image carrier 10 in the standby transition sequence in which the image carrier 10 stops rotating and transitions to the standby state. However, the exposure light may be radiated onto the reverse transfer region D of the image carrier 10 in only one of the image-forming preparation sequence and the standby transition sequence.

In addition, although the image-forming preparation sequence and the standby transition sequence, each of which corresponds to the transition period according to the exemplary embodiment of the present invention, have been described, a sequence of operations including application of the reverse transfer bias to the transfer unit 14 and radiation of the exposure light onto the reverse transfer region D of the image carrier 10, which is influenced by the applied reverse transfer bias, may be performed in either or both of the image-forming preparation sequence and the standby transition sequence and may also be performed in a steady period during which the image carrier 10 rotates at a constant rotational speed.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an image carrier that holds, while rotating, an electrostatic latent image formed through charging and light exposure steps, which are included in a toner-image forming process, and a toner image formed through a development step, which is included in the toner-image forming process, the development step using a toner contained in a developer, which contains the toner and a carrier;
a charger that is disposed at a charging position facing the image carrier and that charges the image carrier as a result of a charging bias being applied to the charger;
an exposure unit that radiates exposure light carrying image information onto the image carrier in such a manner as to form an electrostatic latent image onto the image carrier;
a developing unit that is disposed at a developing position facing the image carrier and that develops the electrostatic latent image on the image carrier with the toner contained in the developer as a result of a developing bias being applied to the developing unit;
a transfer unit that is disposed at a transfer position facing the image carrier and that nips a sheet, which is transported, between the transfer unit and the image carrier and transfers a toner image on the image carrier onto the sheet as a result of a transfer bias being applied to the transfer unit;
a fixing unit that fixes a toner image on a sheet that has been further transported after the toner image has been transferred to the sheet onto the sheet;
a charging-bias power supply that applies the charging bias to the charger in such a manner that voltage is capable of being freely adjusted;
a transfer-bias power supply that applies a reverse transfer bias having a polarity opposite to a polarity of the transfer bias to the transfer unit in a switchable manner; and
a controller that causes the charging-bias power supply to apply the charging bias, which monotonically changes with time, to the charger over a predetermined transition period during a period when the toner-image forming process is not performed, causes the transfer-bias power supply to apply the reverse transfer bias to the transfer unit over a predetermined reverse transfer period within a transit period in which a transient charged region of the image carrier that has passed through the charging position within the transition period passes through the transfer position, and causes the exposure unit to radiate the exposure light onto a reverse transfer region of the image carrier before the reverse transfer region that has passed through the transfer position within the reverse transfer period reaches the developing position.

2. The image forming apparatus according to claim 1,
wherein the transfer unit is a transfer roller that has a substantially roll-like shape and that transfers a toner image on the image carrier onto a sheet while rotating along with rotation of the image carrier, and
wherein the reverse transfer period is a period of time taken for the transfer roller to make about at least one rotation and less than about two rotations.

3. The image forming apparatus according to claim 1,
wherein the controller causes the exposure unit to radiate exposure light having an intensity less than an intensity of the exposure light used in the toner-image forming process onto the reverse transfer region.

4. The image forming apparatus according to claim 1,
wherein the controller causes the exposure unit to radiate the exposure light onto the reverse transfer region in accordance with a usage history such that an intensity of the exposure light decreases as the number of times the image carrier is used increases.

5. The image forming apparatus according to claim 1,
wherein the charger includes a plurality of charging rollers that are arranged in a direction of rotation of the image carrier.

6. The image forming apparatus according to claim 1,
wherein the transition period is at least a period of time before the toner-image forming process is started.

7. The image forming apparatus according to claim 1,
wherein the transition period is at least a period of time after the toner-image forming process has been completed.

8. An image forming apparatus comprising:
an image carrier that holds, while rotating, an electrostatic latent image formed through charging and light exposure steps, which are included in a toner-image forming process, and a toner image formed through a development step, which is included in the toner-image forming process, the development step using a toner contained in a developer, which contains the toner and a carrier;
a charger that is disposed at a charging position facing the image carrier and that charges the image carrier as a result of a charging bias being applied to the charger;
an exposure unit that radiates exposure light carrying image information onto the image carrier in such a manner as to form an electrostatic latent image onto the image carrier;
a developing unit that is disposed at a developing position facing the image carrier and that develops the electrostatic latent image on the image carrier with the toner contained in the developer as a result of a developing bias being applied to the developing unit;
a transfer unit that is disposed at a transfer position facing the image carrier and that nips a sheet, which is transported, between the transfer unit and the image carrier and transfers a toner image on the image carrier onto the sheet as a result of a transfer bias being applied to the transfer unit;
a fixing unit that fixes a toner image on a sheet that has been further transported after the toner image has been transferred to the sheet onto the sheet; and
a controller that causes, during a period when the toner-image forming process is not performed, the reverse transfer bias to be applied to the exposure unit while causing the charging bias applied to the charger to monotonically change and that causes the exposure unit to radiate the exposure light in such a manner as to suppress transfer of the carrier contained in the developer from the developing unit to the image carrier that occurs concomitantly with changes in the charging bias and a change in a charging voltage of the image carrier caused by application of the reverse transfer bias.
